(19) United States
(12) Patent Application Publication
(10) Pub. No.: US 2003/0115340 A1
(43) Pub. Date: Jun. 19, 2003

(54) Data transmission process and system

(76) Inventors: Rafael Linden Sagula, Los Angeles, CA (US); Damien P. Stolarz, Canoga Park, CA (US); Benjamin R. Stragnell, Playa Del Rey, CA (US); Marc A. Fielding, Arcadia, CA (US)

Correspondence Address: Manatt, Phelps & Phillips LLP, Building 2, 1001 Page Mill Road, Palo Alto, CA, 94304, US

(21) Appl. No.: 10/285,922

(22) Filed: Oct. 31, 2002

Related U.S. Application Data
(60) Provisional application No. 60/335,174, filed on Oct. 31, 2001.

(51) Int. Cl. G06F 15/16

(52) U.S. Cl. 709/228; 709/203

(57) ABSTRACT

A hierarchy multicasting system (100) includes multiple clients coupled together in a tree structure (102) through a routing process (300). Data is transmitted from a data source (101) to a root node (112) of the tree structure (102). The root node (112) uses its up-link capacity to reflect the data to its children (122, 124). Through various filtering steps, the routing process (300) optimizes the tree structure (102) for efficiency and reliability. In addition, users (612, 622) behind different firewalls (610, 620) may communicate with each other. Therefore, they can be connected in the same hierarchy multicasting tree structure (600).

### REFERENCE TO PRIOR APPLICATION

Under 35 U.S.C. §119(e), this application for patent claims the benefit of the filing date of U.S. Provisional Application for Patent Serial No. 60/335,174, titled “Live Streamer Distributed Internet Broadcast System” and filed on Oct. 31, 2001.

### FIELD OF THE INVENTION

The present invention relates, in general, to data transmission in a network and, more specifically, to data broadcasting in a distributed network.

### BACKGROUNDS OF THE INVENTION

The advances in computing technology and network infrastructure have provided opportunities for transmitting digital media of many forms with high speed. Business and consumers have become accustomed to receiving large amounts of information over the network. This information may be business oriented, e.g., market reports, product information, etc., or personal use or entertainment oriented, e.g., movies, digital video or audio programs. Information providers or content providers often need to transmit this information to many clients over the network simultaneously.

Transmitting information to multiple clients over the network consumes the resources, e.g., bandwidth, of the content provider sites. As the amount of data transmission approaches the capacity of a content provider site, it will refuse any additional client request. In addition, the speed and overall quality of data transmission often deteriorate as the requested data consume the bandwidth of the content provider. This problem is especially acute for digital video or audio program broadcasting.

In order to solve this problem, the content provider site may mirror its content to one or more server sites, which are also referred to as mirror sites. The mirror sites then transmit data to clients, thereby alleviating the load on the central content provider. However, establishing and maintaining mirror sites place economic burdens on the content providers.

U.S. Pat. No. 6,108,703, titled “Global Hosting System” and issued on Aug. 22, 2000, discloses a distributed hosting framework including a set of content servers for hosting at least some of the embedded objects of a web page that are normally hosted by the central content provider server. The distributed content servers are located closer to the clients than the content provider server and alleviate the load on the content provider server. However, like mirror sites, the content servers are economically inefficient to establish and operate.

U.S. Pat. No. 5,884,031, titled “Method for Connecting Client Systems into a Broadcast Network” and issued on Mar. 16, 1999, discloses a process for connecting client systems into a private broadcast network. The private network has a pyramid structure, with the content provider server at the top and client servers coupled directly or indirectly through other client servers to the content provider server. The pyramid structure allows the content provider server to transmit data to more clients than its server port. However, the pyramid structured private network according to the U.S. Pat. No. 5,844,031 is inefficient in making full use of the network capacity, e.g., bandwidth.

U.S. Pat. No. 6,249,810, titled “Method and System for Implementing and Internet Radio Device for Receiving and/or Transmitting Media Information” and issued on Jun. 19, 2001, discloses a chain casting system, in which the content provider server transmits the information only to a few clients, and then instructs these clients to retransmit the information to other clients. The U.S. Pat. No. 6,249,810 also discloses load balancing in the chain casting system. However, the U.S. Pat. No. 6,249,810 does not teach constructing and adjusting the chain casting system to efficiently utilize the network capacity and achieve high data transmission quality.

In summary, these and other prior data transmission processes are deficient in economic efficiency and data transmission capabilities. They are also deficient in maintaining high data transmission qualities in the system. In addition, the prior art processes cannot establish a data transmission system, in which data is transmitted from one node behind a firewall to another node behind a different firewall.

Accordingly, it would be advantageous to have a data transmission process and system for efficiently transmitting data to multiple clients over a network. It is desirable for the process to establish the data transmission system that is stable and capable of fully utilizing the capacity of the system. It is also desirable to dynamically adjust the data transmission system to maintain high quality data transmission. It would be of further advantage for the data transmission system to efficiently utilize the capacities of the clients in transmitting data. In addition, it would be advantageous to have a process for establishing data transmission links between clients behind different firewalls, thereby enabling the client behind different firewalls to be coupled to the data transmission system and further increasing the flexibility and applications of the data transmission system.

### BRIEF DESCRIPTION OF THE DRAWINGS

FIG. 1 is a schematic diagram illustrating a data transmission system in accordance with the present invention;

FIG. 2 is a block diagram illustrating a process for establishing a hierarchy data transmission system in accordance with the present invention;

FIG. 3 is a flow chart illustrating a routing process for establishing a hierarchy structured multicasting network system in accordance with the present invention;

FIG. 4 is a block diagram illustrating a process for maintaining data transmission quality in a data transmission system in accordance with the present invention;

FIGS. 5A, 5B, and 5C are schematic diagrams illustrating a client reconnection process in accordance with the present invention;

FIG. 6 is a schematic diagram showing a broadcasting system in accordance with the present invention;

FIG. 7 is a block diagram illustrating a process for establishing a data transmission link between an internal node behind a firewall and an external node in accordance with the present invention;

FIGS. 8A, 8B, and 8C are block diagrams illustrating a process for establishing a data transmission link between two nodes behind two different firewalls in accordance with the present invention; and

FIG. 9 is a block diagram illustrating a process for identifying a firewall and its nature in accordance with the present invention.

### DETAILED DESCRIPTION OF VARIOUS EMBODIMENTS

Various embodiments of the present invention are described hereinafter with reference to the figures. It should be noted that the figures are only intended to facilitate the description of specific embodiments of the invention. They are not intended as an exhaustive description of the invention or as a limitation on the scope of the invention. In addition, an aspect described in conjunction with a particular embodiment of the present invention is not necessarily limited to that embodiment and can be practiced in conjunction with any other embodiments of the invention.

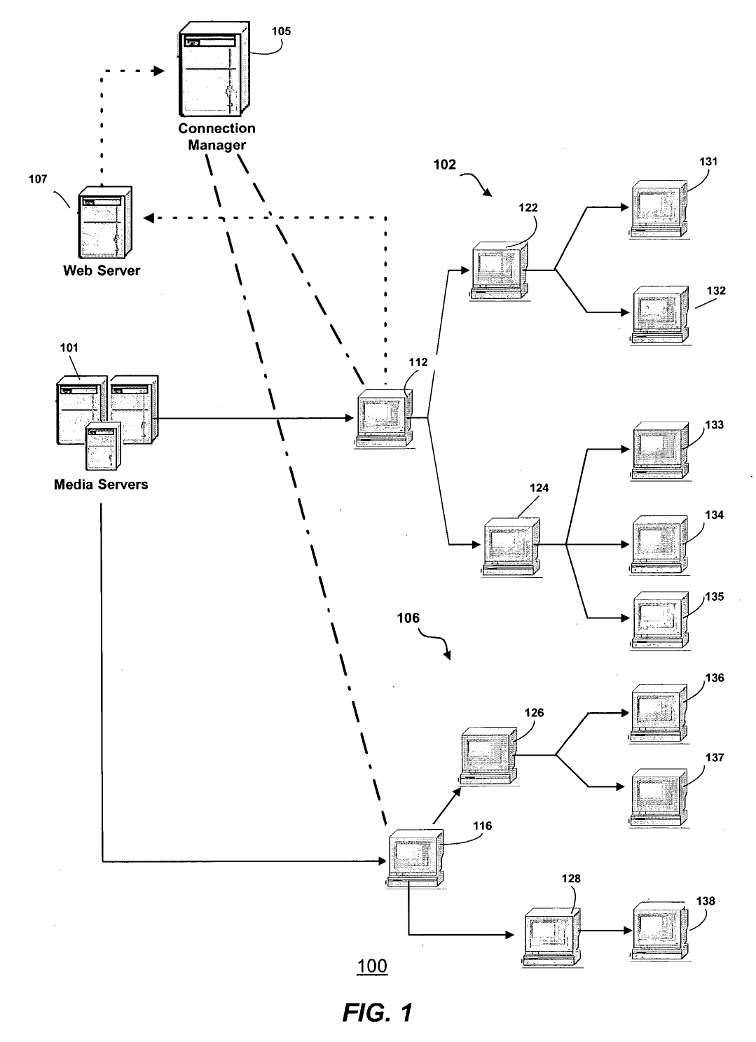

FIG. 1 schematically illustrates a data transmission system 100 in accordance with the present invention. System 100 is for broadcasting data from a content delivery server or content provider 101 to multiple clients over a network, e.g., Internet, Local Area Network (LAN), Intranet, Ethernet, wireless communication network, etc. Data transmitted from content provider 101 to the multiple clients in system 100 can be digital video signals, digital audio signals, graphic signals, text signals, WebPages, etc. Applications of system 100 include digital video or audio broadcasting, market data broadcasting, news broadcasting, business information broadcasting, entertainment or sport information broadcasting, organization announcements, etc.

In accordance with an embodiment of the present invention, the multiple clients receiving data streams from content provider 101 are arranged in a hierarchy structure. By way of example, FIG. 1 shows the clients in system 100 being arranged in a first tree 102 with a first tier client 112 as its root and a second tree 106 with a first tier client 116 as its root.

Tree 102 includes second tier clients 122 and 124 as the children of first tier client 112. Second tier client 122 has third tier clients 131 and 132 as its children. Second tier client 124 has third tier clients 133, 134, and 135 as its children. In tree 106, second tier clients 126 and 128 are two children of first tier client 116. Second tier client 126 has two children, which are third tier clients 136 and 137. Second tier client 128 has a third tier client 138 as its child.

System 100 also includes a client connection manager 105 that arranges the multiple clients into a hierarchy structure and establishes trees 102 and 106 shown in FIG. 1. When a new client requests data transmission, a network server 107 directs the requesting client to client connection manager 105, which places the requesting client in the hierarchy structure for receiving data broadcasting from content provider 101.

Client connection manager 105 maintains a control signal connection with first tier client 112 in tree 102 and first tier client 116 in tree 106, as indicated by dashed lines in FIG. 1. In accordance with one embodiment of the present invention, client connection manager 105 maintains control signal connection only with the first tier clients. A lower tier client, e.g., second tier client 122 or third tier client 134, etc., maintains a control signal connection with its parent. The data regarding the status of the lower tier clients and the tree structure are propagated from the lower tier clients to their respective parents in the tree. In accordance with another embodiment of the present invention, client connection manager 105 maintains control signal connections with clients at multiple tiers or layers. In one embodiment, client connection manager 105 maintains control signal connections to all clients that are not behind a firewall. In another embodiment, client connection manager 105 maintains control signal connections with first and second tier clients. In yet another embodiment, client connection manager 105 selectively maintains control signal connections with certain lower tier clients depending on client characters and the capacity of client connection manager 105.

Maintaining control signal connections only between client connection manager 105 and the top tier clients reduces the load on client connection manager 105, thereby enabling client connection manager 105 to simultaneously construct and manage more tree structures in system 100 or more data transmission systems like system 100. On the other hand, maintaining control signal connections with clients in multiple layers enables client connection manager 105 to efficiently control the hierarchy structure in system 100. It also enables client connection manager 105 to more efficiently locate a client in the hierarchy structure.

In accordance with the present invention, content provider 101 does not transmit data directly to each of the multiple clients in system 100. Instead, content provider 101 transmits data to first tier clients 112 and 116. First tier client 112 in tree 102 transmits or reflects the data to its children, which are second tier clients 122 and 124. Second tier client 122 relays the data to third tier clients 131 and 132. Likewise, second tier client 124 transmits the data to its children, third tier clients 133, 134, and 135. First tier client 116 transmits or reflects the data to its descendents in tree 106 in a process similar to that described herein with reference to first tier client 112.

By arranging clients in a hierarchy structure as shown in FIG. 1, system 100 utilizes the up-link data transmission capacities of some clients at higher tiers to transmit data to other clients at lower tiers. A client in system 100, e.g., first tier client 112, rebroadcasts or reflects the data to its descendents, e.g., second tier clients 122 and 124, and third tier clients 131, 132, 133, 134, and 135. Thus, each client is referred to as a peer of other clients, and system 100 is also referred to as a peer-to-peer data transmission system or a peer-to-peer broadcasting system. The data transmission from content provider 101 to a client at a low tier, e.g., third tier client 137, includes multiple steps of data reception and retransmission. Thus, system 100 is also referred to as a multicasting system, or a cascade broadcasting system. Through multicasting or cascade broadcasting, system 100 significantly reduces the load on content provider 101, thereby enabling content provider 101 to broadcast data to a greater number of clients.

Client connection manager 105 may include a digital signal processing unit, e.g., a microprocessor (μP), a central processing unit (CPU), a digital signal processor (DSP), a super computer, a cluster of computers, etc. By way of example, client connection manager 105 includes general purpose computers for performing the client connection process and managing the client connection in system 100.

It should be understood that data transmission system 100 is not limited to having a structure described herein above and shown in FIG. 1. For example, system 100 is not limited to having two trees with each tree having a depth of three. Depending on the data transmission capacities, e.g., bandwidths, of content provider 101 and the clients receiving data therefrom, system 100 may include any number of trees connected to content provider 101, each tree may have any depth. In addition, system 100 is not limited to having only one content provider as shown in FIG. 1. In accordance with an embodiment of the present invention, client connection manager 105 is capable of directing a requesting client to different content providers based on the content requested by the client and/or available capacity of a particular content provider. Furthermore, client connection manager 105 is not limited to receiving client requests for connection through a single network server 107, as shown in FIG. 1. A client can request connection through any number of network servers in any network, to which client connection manager 105 is coupled.

It should also be understood that system 100 could be implemented using existing network infrastructures. For example, a node in a tree, e.g., the root of tree 102 or the root of tree 106 shown in FIG. 1, can be a content delivery network (CDN) edge server. A CDN edge server typically has a larger data transmission capacity than a client, e.g., first tier client 112 in tree 102, requesting data from content provider 101. Therefore, placing a CDN edge server at a node in the hierarchy structure of data transmission system 100 allows a greater number of clients to be coupled to that node and receive greater data transmission therefrom.

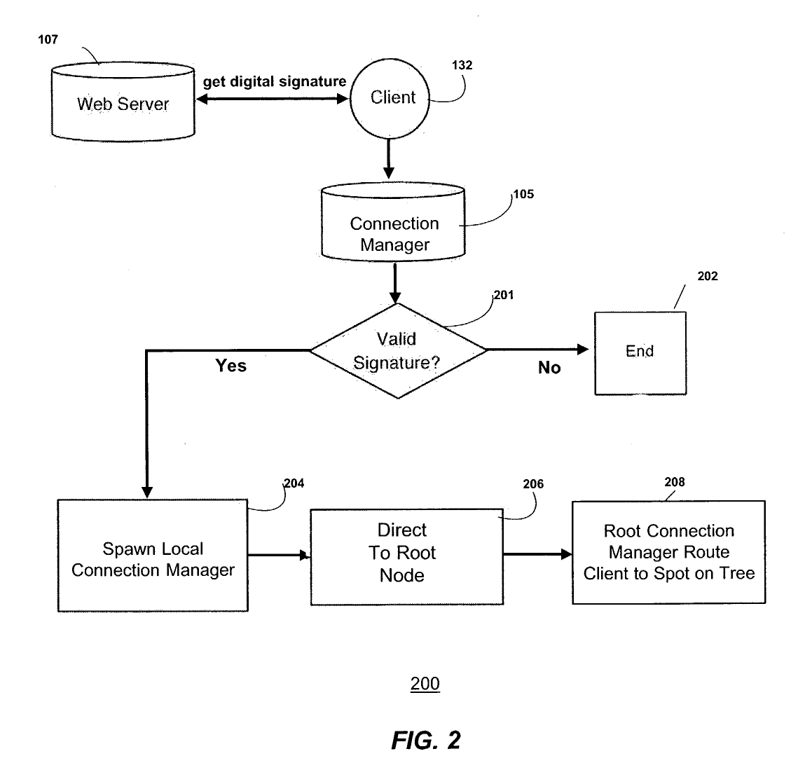

FIG. 2 is a block diagram illustrating a process 200 for establishing a hierarchy data transmission system in accordance with the present invention. By way of example, FIG. 2 illustrates process 200 for connecting client 132 to system 100 shown in FIG. 1. However, this is not intended as a limitation on the present invention. Process 200 is applicable in connecting any client to a hierarchy structure for receiving data transmission in accordance with the present invention.

When a client, e.g., client 132, requests to receive data from a broadcasting source, it first accesses network server 107. Client 132 may request to receive data from the broadcasting source by clicking a web icon of the broadcasting source on network server 107. Network server 107 then assigns a digital signature of client connection manager 105 to requesting client 132 and directs it to client connection manager 105. By way of example, network server 107 directs requesting client 132 to client connection manager 105 by sending the Uniform Resource Locator (URL) of client connection manager 105 to client 132. Client connection manager 105 verifies the digital signature on requesting client 132 in a step 201. If the signature is invalid, client connection manager 105 refuses connection and terminates process 200 in as step 202.

In response to requesting client 132 having a valid digital signature of client connection manager 105, client connection manager 105, in a step 204, spawns a local connection management program to requesting client 132. Subsequently in a step 206, client connection manager 105 directs requesting client 132 to the root of a tree, e.g., tree 102 shown in FIG. 1, connected to a content provider, e.g., content provider 101 shown in FIG. 1, that broadcasts the data requested by client 132. If there is no tree established for receiving the data transmission from content provider 101, client connection manager 105 designates requesting client 132 as a root for a new tree. In a step 208, the local connection management program on the root node in tree 102 routes client 132 to a spot in tree 102 based on data transmission capacities, e.g., bandwidths, that can be allocated to client 132. After being connected in tree 102, client 132 receives data transmission from its parent, second tier client 122. In accordance with one embodiment, client 132 also establishes a control signal connection with its parent, client 122. In accordance with another embodiment referred to as multiple layer control connection, client establishes a control signal connection with client connection manager 105.

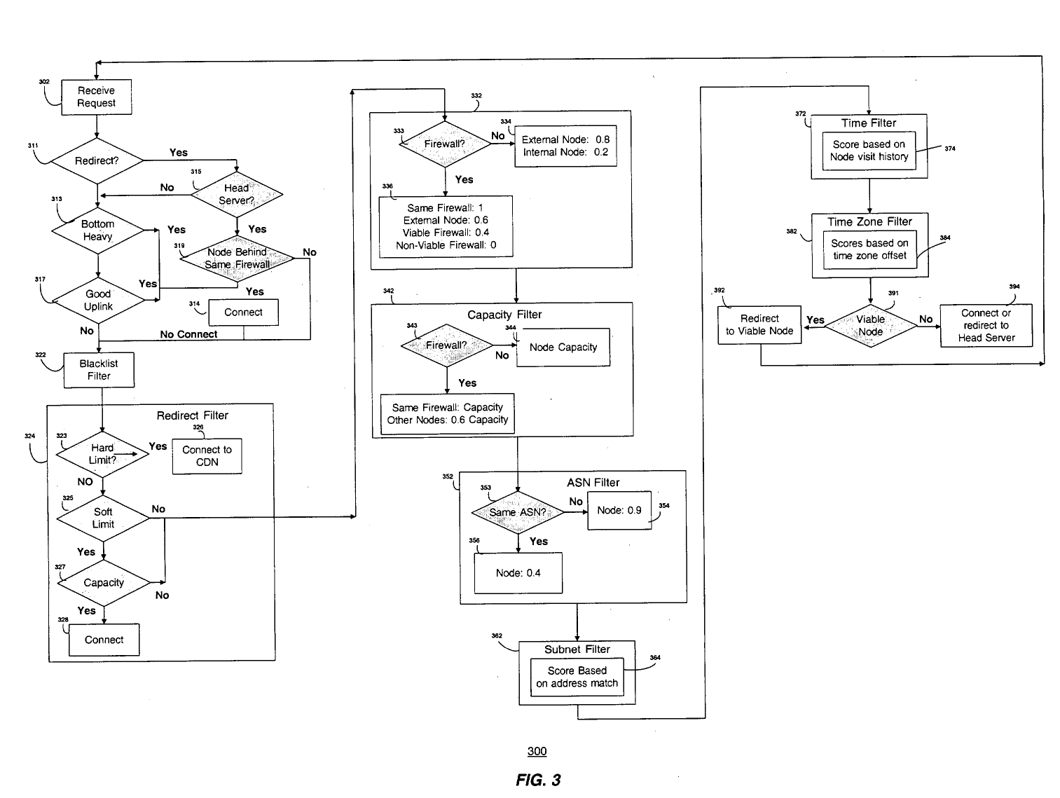

FIG. 3 is a flow chart illustrating a routing process 300 for establishing a hierarchy structured multicasting network system, e.g., system 100 shown in FIG. 1, in accordance with the present invention. By way of example, routing process 300 may serve as routing step 208 in process 200 shown in FIG. 2, for establishing data transmission system 100 shown in FIG. 1. Routing process 300 is a recursive process of routing a client that requests for connection to a port of a node in system 100 depending on the available data transmission capacities in system 100. By routing the requesting client to a node with sufficient capacity available, process 300 establishes system 100 that is both stable and efficient in utilizing the data transmission capacities of the network. For the purpose of describing routing process 300, a node where routing process 300 is currently running is referred to as a current node.

Process 300 starts with a step 302 of accepting a client request for connection at a node in a data transmission system, e.g., data transmission system 100 shown in FIG. 1. In a step 311, process 300 checks whether the requesting client is under redirect. A requesting client under redirect means that the client has gone through at least one failed attempt in connection to a node in the system.

If the request client is not under redirect, process 300, in a step 313, examines a node distribution of a subtree with the current node as its root, i.e., a subtree below the current node. If the request client is under redirect, process 300, in a step 315, checks if the current node is a head server, e.g., client connection manager 105 in system 100 shown in FIG. 1. If the current node is not the head server, process 300 proceeds to step 313 of examining the subtree structure below the current node.

In accordance with one embodiment of the present invention, step 313 of examining or evaluating the node distribution in the subtree structure below the current node includes evaluating a node distribution parameter. In a specific embodiment, the node distribution parameter is defined as a ratio of the total number of descendents over the number of children of the current node. A large ratio indicates the subtree below the current node being bottom heavy in the sense that it has a large number of descendents that are at least two tiers below the current node. On the other hand, a small ratio indicates the subtree below the current node being top heavy in the sense that it has few descendents that are at least two tiers below the current node. Step 313 of evaluating the subtree structure helps process 300 in forming a balanced and stable tree structure for data transmission.

In response to a bottom heavy subtree below the current node, e.g., a node distribution ratio exceeding a range or greater than a predetermined standard value of 5, process 300 proceeds to a step 314. On the other hand, if the subtree below the current node is top heavy, e.g., a node distribution ratio within the range or not exceeding the predetermined standard value of 5, process 300, in a step 317, evaluates the up-link characters of the requesting client. If the requesting client has superior or exceptionally good up-link characters, e.g., large capacity, reliable transmission, etc., process 300 proceeds to step 314. The standards for superior up-link characters can be predetermined in accordance with types of data to be transmitted in the system. Step 317 seeks to locate clients with superior up-link characters in higher tiers in a hierarchy tree structure, thereby utilizing its superior up-link characters in relaying data to lower tier nodes in the tree structure. It is one of various steps in process 300 for optimizing the tree structure in the data transmission system.

It should be noted that the range or standard value for determining whether a tree structure is top heavy or bottom heavy could have different values for different nodes in the data transmission system. For example, when a node is at a relatively high tier, i.e., relatively close to content provider 101 in system 100 shown in FIG. 1, the standard value or the range may be relatively large, e.g., 20. On the other hand, for a node at a relatively low tier, i.e., relatively far away from content provider 101 in system 100 shown in FIG. 1, the standard value or the range may be relatively small, e.g., 4.

If the current node is the head server (step 315), process 300, in a step 319, checks if there is any first tier node, e.g., client 112 or 116 in system 100 shown in FIG. 1, behind the same firewall as the requesting client. If such a node exists and is located, process 300 proceeds to step 314.

In step 314, process 300 connects the requesting client as a child of the current node if the current node has capacity for the requesting client. If the requesting client is behind a firewall, step 314 will try to connect the requesting client as a child of a node in the subtree below the current node that is behind the same firewall as the requesting client. If there is no node in the subtree behind the same firewall as the requesting client, step 314 connects the requesting client to the current node and updates a firewall list to include the firewall address of the requesting client. In accordance with one embodiment, step 314 updates a memory on the current node to include a network firewall address of the requesting client. In accordance with another embodiment, step 314 updates a memory on the head server, e.g., client connection manager 105 shown in FIG. 1, to include a network firewall address of the requesting client.

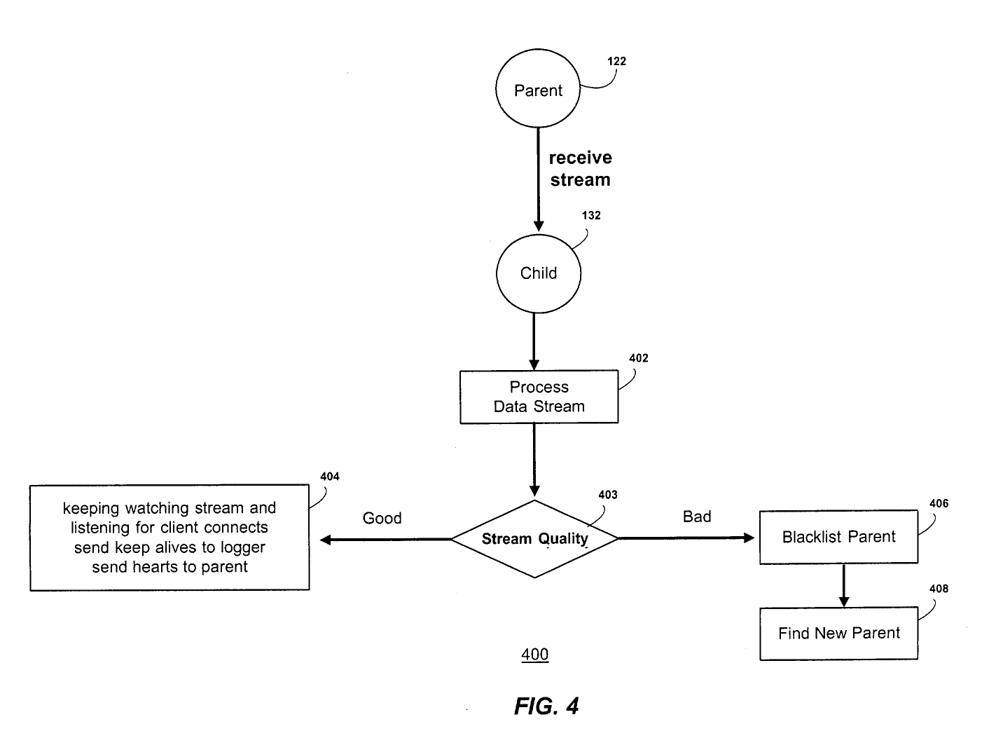

In response to no node available in the subtree that can accommodate the requesting client (step 314), the requesting client not having a superior up-link (step 317), or no first tier nodes behind the same firewall as the requesting client (step 319), process 300 proceeds to a step 322. In step 322, process 300 filters out blacklisted nodes or marked nodes, thereby avoiding connecting the requesting client to the blacklisted nodes. As described herein after with reference to FIG. 4, a client in a data transmission system may seek relocation in the data transmission system. In order to avoid being directed to the same spot, the client blacklists its parent node or identifies its parent node as a marked node before seeking the relocation. Step 322 of blacklist filtering ensures that the client is not routed to the same spot, from which it seeks to be relocated. In one embodiment, step 322 of blacklist filtering assigns a zero score or preference factor to the blacklisted nodes.

In a step 324, process 300 evaluates the redirect status of the requesting client. Specifically, process 300 checks how many times the requesting client has been redirected. A large redirect count indicates that the requesting client has been directed to many spots in the data transmission system without successfully connecting to a node in the system. In a step 323, the redirect count is compared with a first predetermined threshold value. This threshold value is sometimes also referred to as a hard limit. In accordance with the present invention, the hard limit can be any positive integer, e.g., 5, 8, 15, etc. The hard limit can also be infinity, in which case, the redirect count is always below the hard limit. Accordingly, process 300 actually does not have a hard limit for the redirect status.

In response to the number of redirects, e.g., the redirect count exceeding the hard limit, process 300 terminates the routing effort and, in a step 326, connects the requesting client directly to content provider 101 and establishes a control signal connection between client connection manager 105 and the requesting client. If content provider 101 does not have capacity for the requesting client, process 300 refuses the connection request of the requesting client.

In response to the number of redirects not exceeding the hard limit, process 300, in a step 325, compares the redirect count with a second predetermined threshold value. This threshold value is sometimes also referred to as a soft limit. In accordance with an embodiment of the present invention, the soft limit can be any positive integer, e.g., 5, 10, 20, etc., less than the hard limit. If the soft limit is equal to or greater than the hard limit, step 325 of soft limit verification has no effect on the routing of the requesting client and process 300 has only the hard limit for the redirect count.

In response to the redirect count exceeding the soft limit, process 300, in a step 327, checks whether the current node has capacity for the requesting client. If the current node has capacity for the requesting client, process 300, in a step 328, connects the requesting client to the current node.

In response to the redirect count not exceeding the soft limit (step 325) or the current node not having capacity for the requesting client (step 327), process 300, in a step 332, activates a firewall filter. The firewall filter assigns scores or preference factors to the current node depending on the firewall compatibility between the requesting client and the current node. It assigns higher scores to a node with compatible firewall characters with the requesting client, thereby directing the requesting client to a node with compatible firewall characters and avoiding connecting the requesting client to a node with incompatible firewall characters. In a step 333, process 300 checks if the requesting client is behind a firewall.

If the requesting client is not behind a firewall, process 300 proceeds to a step 334. Step 334 assigns a high score, e.g., 0.8, to the current node in response to the current node not behind a firewall either and assigns a low score, e.g., 0.2, to the current node in response to the current node behind a firewall.

On the other hand, if the requesting client is behind a firewall, process 300, in a step 336, assigns different scores to the current node depending on its firewall characters. In accordance with an embodiment of the present invention, a high score, e.g., 1, is assigned to the current node if it is behind the same firewall as the requesting node; a medium high score, e.g., 0.6, is assigned to the current node if it is not behind any firewall; a medium low score, e.g., 0.4, is assigned to the current node if it is behind a different firewall from that of the requesting client, but viable data transmission can be established between the requesting client and the current node through the firewalls; and a low score, e.g., 0, is assigned to the current node if it is behind a different firewall from that of the requesting client and no viable data transmission can be established between the requesting client and the current node through the firewalls.

In accordance with an embodiment of the present invention, process 300 includes a capacity filtering step 342 for assigning scores to the current depending on its available capacity. In a step 343, process 300 first checks if the requesting client is behind a firewall. In one embodiment of the present invention, if the requesting client is not behind a firewall, the current node is assigned a score equal to its available capacity in a step 344. If the requesting client is behind a firewall, a step 346 assigns to the current node a score equal to its available capacity in response to the current node behind the same firewall as the requesting client. Otherwise, step 346 assigns to the current node a score equal to its available capacity multiplied by a factor smaller than one, e.g., 0.6. The capacity filter gives high preferences to nodes with high capacities and with compatible firewall characters with the requesting client.

In accordance with an embodiment of the present invention, process 300 also includes an Autonomous System Number (ASN) filtering step 352. In a step 353, process 300 checks if the current node has the same ASN as the requesting client. If the current node has the same ASN number as the requesting client, process 300, in a step 354, assigns a high score, e.g., 0.9, to the current node. Otherwise, in a step 356, process 300 assigns a low score, e.g., 0.4, to the current node. By assigning high scores to the nodes having the same ASN as the requesting client, process 300 directs the requesting client to the nodes that are in the same Autonomous System as the requesting client. Connecting the requesting client to a node in the same Autonomous System is beneficial in improving the efficiency and reliability data transmission between the node and the requesting client.

In accordance with an embodiment of the present invention, process 300 further includes a subnet filtering step 362. In a step 364, process 300 assigns scores to the current node depending on the subnet relation between the requesting client and the current node. A high score, e.g., 1, is assigned to current node if it has a network address with all four quartets matching that of the requesting client. In response to a decreasing number of matching quartets in the network addresses, a lower score is assigned to the current node. By assigning high scores to the nodes having the matching network addresses as the requesting client, process 300 directs the requesting client to the nodes that are in the same subnet as the requesting client. Connecting the requesting client to a node in the same subnet is beneficial in improving the efficiency and reliability of data transmission between the node and the requesting client.

Furthermore, in accordance with an embodiment of the present invention, process 300 includes a time filtering step 372. Time filtering step 372 keeps track of when and how frequently a node in the data transmission system is visited by clients seeking for connection to the node. In a step 374, process 300 assigns to the current node a score based on the time and frequency of visits to the node by clients. In a preferred embodiment, step 374 assigns a high score, e.g., 1, to the current node in response to the current node not being visited by a client for a predetermined time period, e.g., 3 minutes, and assigns a low score, e.g., 0.2, to the current node in response to the current node being visited within another predetermined period, e.g., 30 seconds. Other scores may be assigned to the current node depending on its history of visits by clients in accordance with various embodiments of the present invention.

Time filtering step 372 prevents a node in the hierarchy data transmission system from being over visited. This is beneficial in keeping the hierarchy tree structures balanced and stable. This is also beneficial in spread the data transmission loads throughout the system and making efficient use of the data transmission capabilities in the system.

In addition, in accordance with an embodiment of the present invention, process 300 includes a time zone filtering step 382. Specifically in a step 384, process 300 assigns scores to the current node depending on the time zone relation between the requesting client and the current node. A high score, e.g., 1, is assigned to the current node if it is in the same time zone as the requesting client. Lower scores are assigned to the current node in response to larger time zone offsets between the current node and the requesting client. By assigning high scores to the nodes with small time zone offsets from the requesting client, process 300 directs the requesting client to the nodes that are geographically close to the requesting client. Connecting the requesting client to a geographically close node is beneficial in improving the efficiency and reliability data transmission between the node and the requesting client.

In a step 391, process 300 checks if there are nodes in the subtree below the current node that remain viable after various filtering steps. In accordance with one embodiment, a viable node is a node that is not marked or blacklisted and has a score equal to or greater than a predetermined minimum value. In accordance with another embodiment, a viable node is any node that has a non-zero score. If there are viable nodes, process 300, in a step 392, picks a set of viable nodes with high scores, e.g., 10 nodes with the highest scores, and increases the redirect count of the requesting client by 1. Process 300 then proceeds to step 302 and starts another iteration of the recursive routing process with one of the viable nodes picked in step 392 as the current node. If there is no viable node left, process 300, in a step 394, connects the requesting client as a child of the current node if the current node has capacity for the requesting client. If the current node has no capacity for the requesting client, step 394 increases the redirect count of the requesting client and redirects the requesting client to the head server for another attempt to be connected into the data transmission system.

Routing process 300 establishes a hierarchy structured multicasting or cascade broadcasting system for clients receiving data transmissions. By using the up-link capacities of the nodes in the hierarchy structure, the multicasting system distributes the data transmission load over the entire system. It significantly reduces the load on the content provider, thereby allowing more clients to receive the data without overloading the content provider.

In accordance with an embodiment of the present invention, process 300 recursively searches for a node for connecting the requesting client. When the current node is a root node of a bottom heavy subtree structure, process 300 gives preference to connecting the requesting client as a child of the current node. When the current node is a root node of a top heavy subtree, process 300 give preference to connecting the current node to a descendent of the current node. In other words, process 300 seeks to construct a balanced hierarchy tree structure. Therefore, process 300 establishes a hierarchy tree structure that is both efficient in utilizing the network data transmission capacity and resource and stable.

Process 300 also gives preference to placing a requesting client that is behind a firewall below a node behind the same firewall. If there is no node in the tree behind the same firewall as the requesting client, process 300 updates its cache of the firewall address list to include the firewall address of the requesting client and connects the requesting client to the tree. When a next client requesting for connection is behind the same firewall, process 300 connects it to a node below the requesting client. By grouping clients behind the same firewall together, process 300 maintains the integrity of the firewall and makes efficient use of the network data transmission capacity.

Through various filtering steps, process 300 assigns high scores to the nodes that can transmit data to the requesting client with high efficiency or reliability. For example, high scores are assigned to the nodes with high data transmission capacity for the requesting client, the nodes with the same ASN as the requesting client, the nodes in the same subnet as the requesting client, the nodes geographically close to the clients, etc. These filtering steps are beneficial in improving the data transmission efficiency and reliability of the system.

It should be understood that routing process 300 in accordance with the present invention is not limited to that described herein above with reference to FIG. 3. Various modifications can be made to the described process without departing from the spirit of the present invention. For example, time zone filtering can be replaced with a geographic location filtering based on global positioning system (GPS) data. Time zone filtering is also optional in accordance with the present invention. If process 300 is used to construct data transmission system covering clients in a relatively small geographic region, the benefit of time zone filtering becomes relatively minor. Likewise, if all clients are in the same Autonomous System or in the same subnet, the ASN filtering or subnet filtering step can be deleted from process 300 without adversely affecting the efficiency and reliability of the data transmission system.

After the requesting client is connected to a port of a node in a tree, it becomes a child of the node. For example, when third tier client 132 is connected to a port of second tier client 122, as shown in FIG. 1, it becomes a node in tree 102 and a child of second tier client 122. A client in a tree, e.g., third tier client 132 in tree 102, has a list of node addresses, which may be a list of URLs, that includes the addresses of client connection manager 105, its parent, e.g., second tier client 122, and its siblings. As a client, e.g., third tier client 132, receives data streams from its parent, e.g., second tier client 122, it monitors the quality of data stream. If the quality of data stream from its parent falls below a predetermined standard, the client seeks to reconnect itself to another node in the hierarchy structure, e.g., in tree 102 or tree 106, as shown in FIG. 1.

FIG. 4 is a block diagram illustrating a process 400 for maintaining data transmission-quality in a data transmission system, e.g., data transmission system 100 shown in FIG. 1, in accordance with the present invention. In data transmission system 100, client 132 receives data stream from its parent client 122. In a step 402, client 132 processes the data stream. Processing the data stream may include displaying the data, storing the data, merging the data with other data, encoding the data, decoding the data, decoding the data to play a video or audio program, etc.

In a step 403, client 132 examines the quality of the data stream received from parent client 122. In other words, client 132 examines the Quality of Service (QoS) from parent client 122. By way of example, data packet loss is a commonly used measurement of the data stream quality. Also by way of example, jitter is another measurement of the data stream quality. The jitter measures the difference between the expected timestamp and the actual timestamp on a data packet. In a network adopting Transmission Control Protocol (TCP), complete delivery of data packets is guaranteed through resends, and data packet loss is always zero. In some applications, the timeliness of the data packets is more important than the completeness of the data packets. For example, a video program stream on client 132 can continue with minor visual glitches or imperfections if the majority of the data packets arrives in a timely fashion with some minor data loss, but will stop dead if client 132 waits for a series of sends and resends of the data packets. In these applications, jitter is a more appropriate measurement of data stream quality than data packet loss.

If the quality of the data stream meets a predetermined standard or is otherwise satisfactory, client 132, in a step 404, sends a signal through a control signal connection back to its parent client 122 indicating the satisfactory quality of the data stream. Optionally, client 132 further informs the local connection management program that client 132 is in good connection condition with its parent. Client 132 continues to receive data streams from its parent and is ready to accept new clients as its children if it has sufficient capacity.

If the quality of the data stream or QoS does not meet the predetermined standard or is otherwise unsatisfactory, client 132, in a step 406, identifies its parent client 122 as a marked node or blacklists its parent client 122. Client 132 further informs the local connection management program about the poor connection condition with its parent. In a step 408, the local connection management program on client 132 seeks to reconnect client 132 to another node in the hierarchy structure in system 100 shown in FIG. 1.

In accordance with an embodiment of the present invention, client 132 first seeks to be connected to one of its siblings, e.g., client 131 in tree 102 shown in FIG. 1. Redirecting client 132 to one of its siblings has a small impact on the overall hierarchy structure in system 100 shown in FIG. 1. It is also efficient because a routing process, e.g., routing process 300 described herein above with reference to FIG. 3, needs to iterate fewer times compared with redirecting client 132 to another node far away from its current node. Furthermore, client 132 and its siblings are probably behind the same firewall, in the same Autonomous System, in the same subnet, in the same time zone, etc. Therefore, seeking to redirect a client to its siblings is beneficial in keeping a data transmission network balanced without increasing the traffic on the entire network. It is also beneficial in producing necessary network restructuring without unnecessary network chattering. It is further beneficial in maintaining the integrity of the firewalls in the network.

If client 132 has no sibling or its siblings have no capacity to be allocated to it, client 132 requests reconnection to client connection manager 105 in system 100 shown in FIG. 1. Client connection manager 105 executes a routing process, e.g., routing process 300 described herein above with reference to respective FIG. 3, to connect client 132 to a new node in data transmission system 100 shown in FIG. 1. In accordance with the present invention, the routing process does not route client 132 to the marked node, i.e., the blacklisted parent of client 132, before client 132 seeks reconnection.

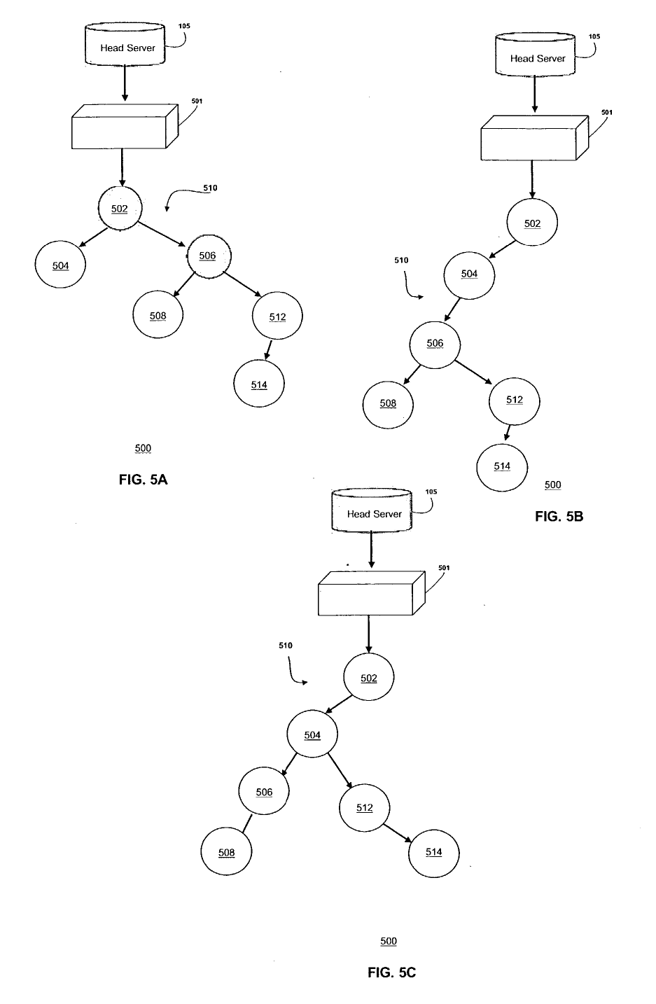

FIGS. 5A, 5B, and 5C schematically show a tree 500 for illustrating a client reconnection process in accordance with the present invention. Tree 500 has client connection manager 105 as its root server or head server. A client 502 is coupled to client connection manager 105. A block 501 between client connection manager 105 and client 502 represents unspecified hierarchy structures between client connection manager 105 and client 502. Block 501 may include any number of clients arranged in any kind of hierarchy structures; and client 502 is a child of a node in a hierarchy structure in block 501. On the other hand, block 501 may be empty or not include any node that is a parent of client 502. In either of these situations, client 502 is directly connected to client connection manager 105. It should be noted that client connection manager 105 transmits controls signals to the nodes in tree 500. A data stream source (not shown in FIGS. 5A-5C) broadcasts data streams to the nodes in tree 500. By way of example, content provider 101 in system 100 shown in FIG. 1 can serve as a data stream source for data transmission in tree 500.

As shown in FIG. 5A, client 502 is the root of a portion or a branch 510 of tree 500. Branch 510 includes clients 504 and 506 as the children of client 502. Client 506 has two children, which are clients 508 and 512. Branch 510 further includes a client 514, which is a child of client 512. Each client has a list of node addresses, which includes the addresses of client connection manager 105, the client's parent, and the client's siblings.

During a broadcasting or data transmission process, clients 504 and 506 receive data streams from client 502. Client 506 retransmits, relays, or reflects the data streams to clients 508 and 512. Client 512 relays the data streams to client 514. As described herein above with reference to FIG. 4, each client examines the quality of data stream or QoS from its parent. By way of example, client 506 experiences a poor QoS. As described herein above with reference to FIG. 4, client 506 identifies its parent client 502 as a marked node or blacklists its parent client 502, and seeks to be redirected to another node in tree 500.

Client 506 first seeks to be connected to one of its siblings. As shown in FIG. 5A, client 506 has a sibling client 504. In response to client 504 having capacity to be allocated to it, client 506 is reconnected to tree 500 as a child of client 504, as shown in FIG. 5B. Client 506 now receives data streams from client 504 and reflects the data streams to clients 508 and 512, which in turn relays the data streams to its child client 514.

In accordance with an embodiment of the present invention, client 506 identifies the unbalanced structure in branch 510 as shown in FIG. 5B. In order to balance the tree structure, client 506 instructs client 512 to be disconnected from client 506 and redirects client 512 to client 504. Client 512 is reconnected to branch 510 as a child of client 504 and a sibling of client 506, as shown in FIG. 5C. Branch 510 of tree 500 is balanced.

If client 504 does not have capacity to be allocated for client 506, client 506 generates a reconnection request. In response to the reconnection request, client connection manager 105 searches a spot in tree 500 for client 506 through a routing process, e.g., routing process 300 described herein above with reference to FIG. 3. Because the parent of client 506, client 502, is marked or blacklisted, the routing process does not relocate client 506 to be a child of its former parent, client 502.

It should be understood that first trying to be connected to its sibling when a client seeking for reconnection, as described herein above with reference to FIGS. 4 and 5A-5C, is optional in accordance with the present invention. In accordance with an alternative embodiment of the present, a client seeking for reconnection generates a reconnection request to the head server, e.g., client connection manager 105 without first trying to be connected as a child of its sibling. In accordance with another alternative embodiment of the present invention, seeking to be connected to its sibling before generating a reconnection request to the head server is applicable when the client seeking reconnection and its parent are behind the same firewall. For a client not behind the same firewall as its parent, a request for reconnection is generated and propagated to the head server in response to the client seeking reconnect. This approach is beneficial in grouping the clients behind the same firewall together, thereby improving the data transmission efficiency and maintaining the firewall integrity.

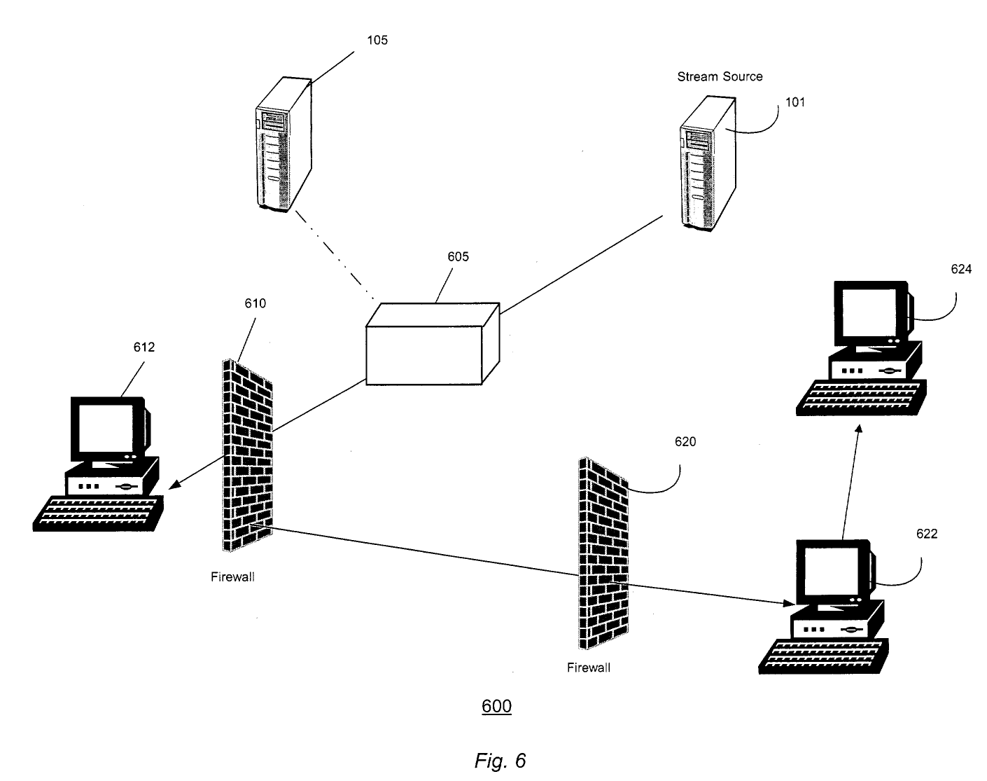

FIG. 6 is a schematic diagram illustrating a network broadcasting system 600 in accordance with an embodiment of the present invention. System 600 has client connection manager 105 as its head server and data stream source 101 for broadcasting data to the nodes in system 600. A client 612 is coupled to client connection manager 105. A block 605 between client connection manager 105 and client 612 represents unspecified control signal connections between client connection manager 105 and client 612. Block 605 also represents unspecified data transmission paths between data stream source 101 and client 612. Block 605 may include any number of clients arranged in any kinds of hierarchy structures. Client 612 is a child of a node in a hierarchy structure in block 605. On the other hand, block 605 may be empty or not include any node that is a parent of client 612. In either of these situations, client 612 is directly connected to client connection manager 105 for control signals and directly connected to data stream source 101 for data streams. Client 612 has a client 622 as its child. A client 624 is a child of client 622. As shown in FIG. 6, client 612 is behind a firewall 610, and clients 622 and 624 are behind a firewall 620, which is a different firewall from firewall 610.

Coupling client 612 to client connection manager 105 and data stream source 101 requires data transmission from an external site, e.g., a node in block 605, client connection manager 105, or data stream source 101, to an internal site behind firewall 610. In addition, connecting client 622 as a child of client 612 in system 600 requires data transmission between a site behind one firewall, i.e., client 612 behind firewall 610, and another site behind a different firewall, i.e., client 622 behind firewall 620.

A firewall functions to filter incoming data packets before relaying them to a client behind the firewall. Typically, a firewall is deployed so that an internal site behind the firewall can access an external site outside the firewall, but the external site cannot form connections to the internal site. The functionality of a firewall can be performed by a Network Address Translator (NAT), which is a gateway device that allows many users to share one network address. A NAT prevents data packets from an external source from reaching a client behind or inside the firewall, unless the data packets are part of a connection initiated by the client behind or inside the firewall.

A firewall or a NAT keeps track of which internal machines have initiated signal transmissions or conversations with which external sites in a masquerading table. The firewall relays the data packets arriving from an external site that are recognized as a part of an existing conversation with an internal site to the internal site that initiated the conversation. The firewall blocks and discards all other data packets. Therefore, the firewall prevents an external site from initiating conversation with an internal site.

There are generally three kinds of firewalls or NAT gateways. A strict firewall blocks an incoming data packet addressed to a firewall port unless both the source site address and the source port match the entries in the masquerading table. A semi-promiscuous firewall, which is non-strict, permits an incoming data packet addressed to a firewall port if the source site address matches that entry in the masquerading table and relays the data packet to the internal site that opened the firewall port. A promiscuous firewall, which is also non-strict, permits an incoming data packet addressed to a firewall port and relays the data packet to the internal site that opened the firewall port.

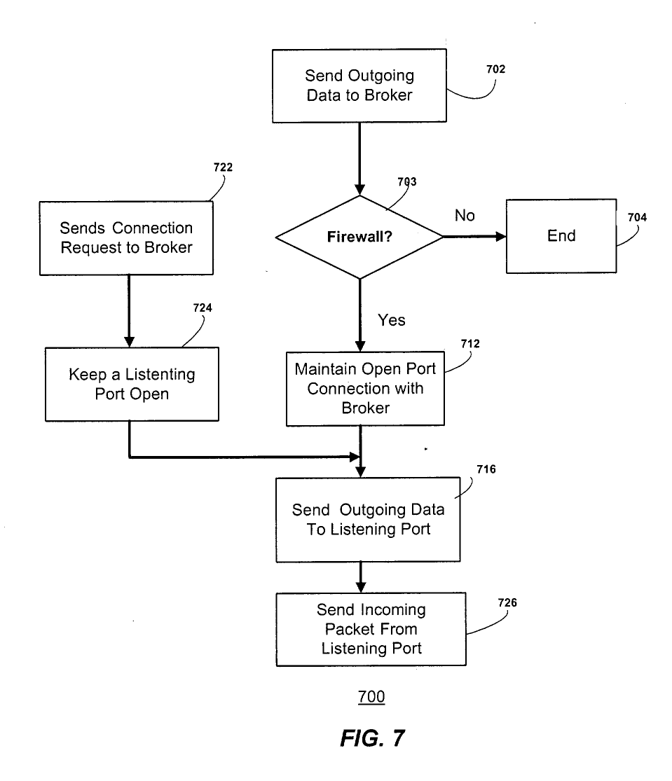

FIG. 7 is a flow chart illustrating a process 700 for establishing a data transmission link or connection between an internal site inside a firewall with an external site in accordance with the present invention. By way of example, the internal site behind the firewall may be client 612 behind firewall 610 in system 600 shown in FIG. 6. Also by way of example, the external site may be a parent node of client 612 in block 605, data stream source 101, or client connection manager 105 in system 600, as shown in FIG. 6.

The firewall permits an internal site to initiate a connection request to an external site, but prevents the external site from initiating a connection request to an internal site. Process 700 enables an external site to initiate a connection request to an internal site with the help of an intermediate site outside the firewall, which is also referred to as a firewall connection broker or simply a broker. In an initialization step 702, the internal site sends from behind a gateway an outgoing signal to the broker. In a step 703, process 700 verifies whether the internal site is behind a firewall, i.e., whether the gateway is really a firewall, and the nature of the firewall. If the internal site is not behind a firewall, data transmission between the site and any other external site can be accomplished directly. Process 700, therefore, proceeds to a finishing step 704.

In response the internal site, e.g., client 612, behind a firewall. Client 612 maintains an open port connection on firewall 610 with the broker in a step 712. When an external site seeks connection with client 612, it sends a connection request to the broker in a step 722. In a step 724, the broker instructs the external site to keep a listening port open. In a step 716, the broker transmits a signal through the open port connection on firewall 610 with the broker to client 612 and instructs client 612 to send an outgoing data packet to the listening port of the external client. The outgoing data packet opens a port of firewall 610 and generates an entry of the listening port of the external site on the masquerading table on firewall 610. In a step 726, the external site sends an incoming data packet from its listening port addressed to the open port on firewall 610. Firewall 610, in a step 718, matches the source address and source port of the incoming data packet with the entries on the masquerading table and relays the data packet to client 612. A data transmission link is thereby established between the external site and client 612 behind firewall 610.

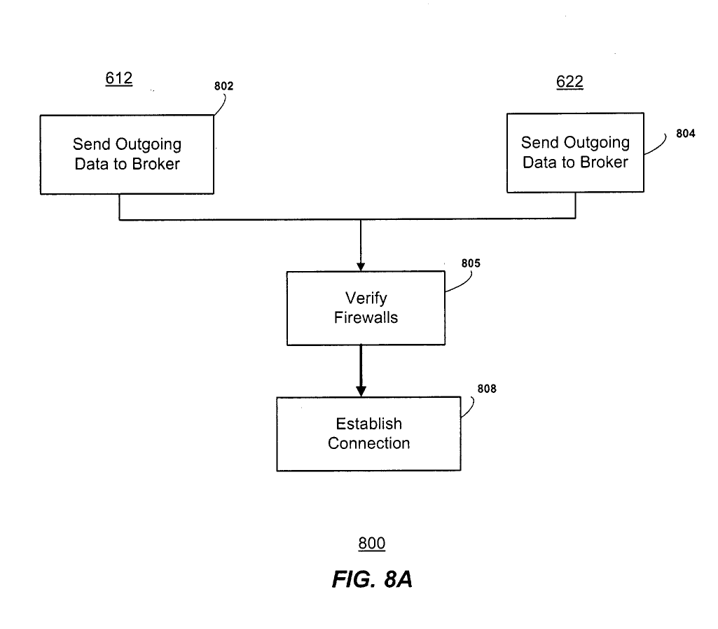

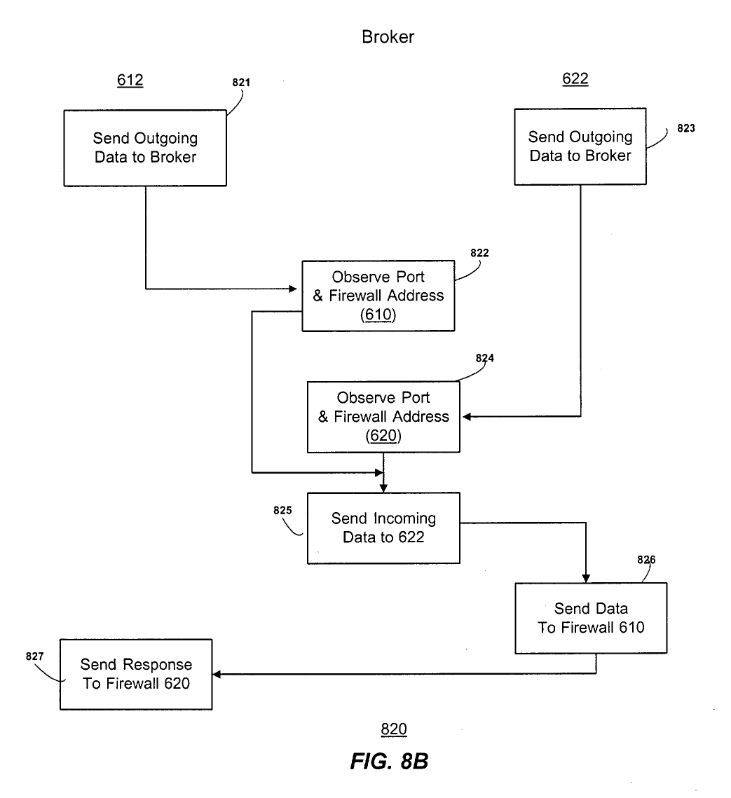

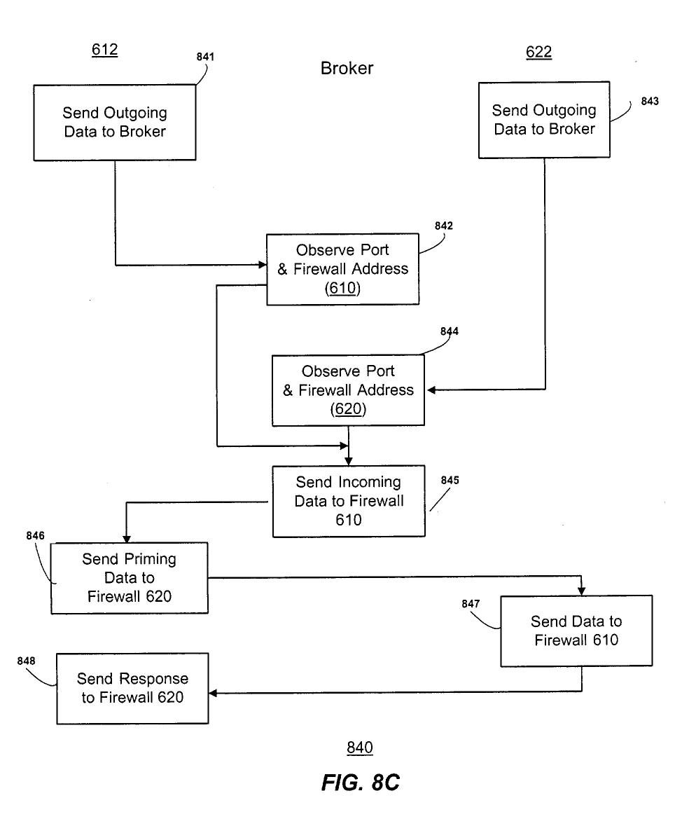

FIG. 8A is a flow chart illustrating a process 800 for establishing a data transmission link or connection between two internal sites behind two different firewalls in accordance with the present invention. By way of example, one internal site behind the firewall may be client 612 behind firewall 610 in system 600 shown in FIG. 6. Also by way of example, another internal site behind the firewall may be client 622 behind firewall 620 in system 600 shown in FIG. 6. Process 800 enables two internal sites behind different firewalls to establish a signal transmission connection or link there between with the help of an intermediate site outside the firewall, which is also referred to as a firewall connection broker or simply a broker.

Referring now to FIG. 8A, in an initialization step 802, client 612 behind gateway 610 sends an outgoing signal to the broker. Likewise, client 622 behind gateway 620, in a step 804, sends an outgoing signal to the broker. In a step 805, the broker verifies whether gateways 610 and 620 are really firewalls and identifies the nature of the firewalls. Process 800 then proceeds to a step 808 of establishing data transmission links between client 612 and client 622. If neither gateway 610 nor gateway 620 is a firewall, clients 612 and 622 can send data packets directly to each other and establish data transmission links there between. If either gateway 610 or gateway 620, but not both, is a firewall, clients 612 and 622 can establish data transmission links there between in processes similar to that described herein above with reference to FIG. 7.

FIG. 8B illustrates a process 820 for establishing a data transmission link between two sites behind two different firewalls with at least one of the two firewalls being promiscuous in accordance with the present invention. Process 820 can serve as step 808 in process 800 shown in FIG. 8A. By way of example, process 820 is described in the context of establishing a data transmission link between client 612 behind firewall 610 and client 622 behind firewall 620, as shown in FIG. 6. Also by way of example, firewall 610 is a promiscuous firewall.

In a step 821, client 612 sends an outgoing data packet through a port on firewall 610 to the broker. The broker observes the address of firewall 610 and the open port thereon in a step 822. In a Step 823, client 622 sends an outgoing data packet to the broker requesting for connection with client 612. The broker, in a step 824, observes the address of firewall 620 and the open port thereon. In a step 825, the broker sends a message through the open port on firewall 620 to client 622. The message contains the network address of firewall 610 and the open port thereon. In a step 826, client 622 opens a new port on firewall 620 and sends an outgoing message addressed to the open port on firewall 610. Because firewall 610 is promiscuous, it permits an incoming data packet addressed to the open port thereon and relays the data packet to client 612. In a step 827, client 612 sends a response message to the new port on firewall 620. Because firewall 620 recognizes the source address and source port of the response message as entries in its masquerading table, it relays the response message to client 622 in a step 828, thereby establishing a data transmission link between client 612 behind promiscuous firewall 610 and client 622 behind firewall 620.

Process 820 described herein above with reference to FIG. 8B is applicable in situations where firewall 610 is promiscuous and regardless of whether firewall 620 is strict, semi-promiscuous, or promiscuous. Therefore, a process reverse to process 820 can be used to establish a data transmission link between client 612 and client 622 in response to firewall 610 being strict or semi-promiscuous and firewall 620 being promiscuous.

FIG. 8C illustrates a process 840 for establishing a data transmission link between two sites behind two different firewalls with one of the two firewalls being semi-promiscuous and the other firewall being either semi-promiscuous or strict in accordance with the present invention. Process 840 can serve as step 808 in process 800 shown in FIG. 8A. By way of example, process 840 is described in the context of establishing a data transmission link between client 612 behind firewall 610 and client 622 behind firewall 620, as shown in FIG. 6. Also by way of example, firewall 610 is a semi-promiscuous firewall.

In a step 841, client 612 sends an outgoing data packet through a port on firewall 610 to the broker. The broker observes the address of firewall 610 and the open port thereon in a step 842. In a Step 843, client 622 sends an outgoing data packet to the broker requesting for connection with client 612. The broker, in a step 844, observes the address of firewall 620 and the open port thereon. In a step 845, the broker sends a message through the open port on firewall 610 to client 612. The message instructs client 612 to send an outgoing data packet, which is also referred to as a priming packet, through the open port on firewall 610 to a port on firewall 620. In a step 846, client 612 sends the priming data packet addressed to a port on firewall 620, and firewall 610 enters the network address of firewall 620 into its masquerading table. The priming data packet is blocked and discarded by firewall 620. In a step 847, client 622 sends an outgoing data packet through a new port on firewall 620 addressed to the open port on firewall 610. Because firewall 610 is semi-promiscuous and recognizes firewall 620 as an entry in its masquerading table at the open port, firewall 610 relays the data packet to client 612. In a step 848, client 612 sends a response message to the new port on firewall 620. Because firewall 620 recognizes the source address and source port of the response message as entries in its masquerading table, it relays the response message to client 622, thereby establishing a data transmission link between client 612 behind semi-promiscuous firewall 610 and client 622 behind firewall 620.

Process 840 described herein above with reference to FIG. 8C is applicable in situations where firewall 610 is semi-promiscuous and regardless of whether firewall 620 is strict, semi-promiscuous, or promiscuous. Therefore, a process reverse to process 840 can be used to establish a data transmission link between client 612 and client 622 in response to firewall 610 being strict and firewall 620 being semi-promiscuous.

It should be noted that process 840 described herein with reference to FIG. 8C is also applicable if firewall 610 is a promiscuous firewall. In summary, process 840 is capable of establishing data transmission links between two internal sites behind two different firewalls, with at least one of the two firewalls being non-strict, i.e., either promiscuous or semi-promiscuous. On the other hand, process 820 described herein above with reference to FIG. 8B is capable of establishing data transmission links between two internal sites behind two different firewalls, with at least one of the two firewalls being promiscuous.

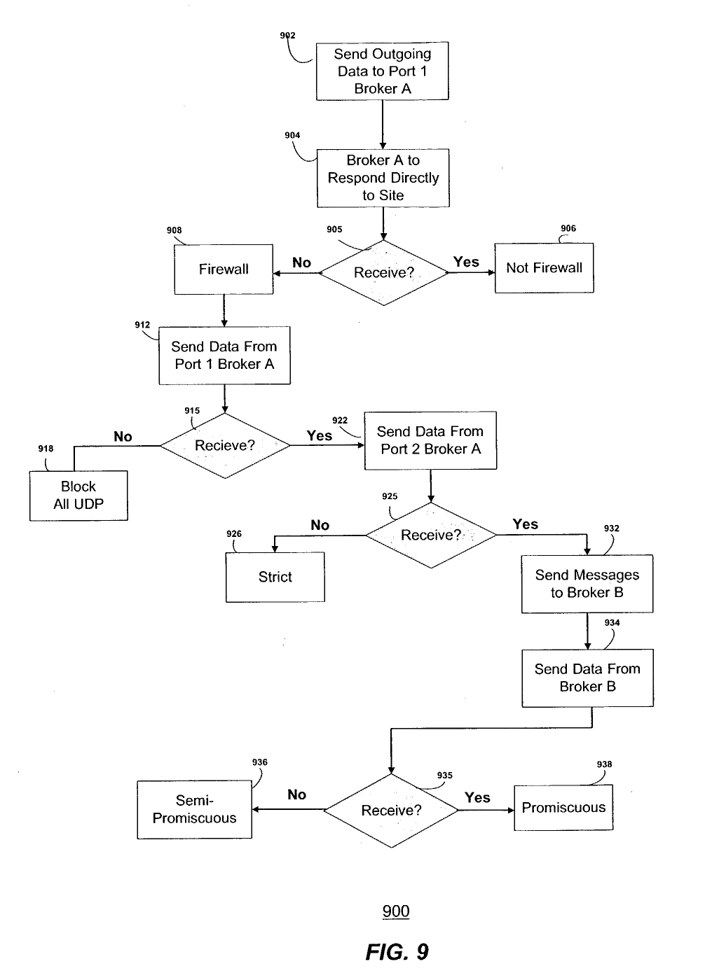

FIG. 9 illustrates a process 900 for identifying the nature of a gateway in accordance with the present invention. Specifically, process 900 verifies whether a gateway, e.g., a NAT gateway, is a firewall and identifies what kind of firewall the gateway is if it is a firewall. By way of example, process 900 can serve as step 703 of verifying whether client 612 is behind a firewall in process 700 described herein above with reference to in FIG. 7. Also by way of example, process 900 can serve as step 805 of verifying whether gateways 610 and 620 are really firewalls and the nature of the firewalls in process 800 described herein above with reference to FIG. 8A. However, these applications are not intended as limitations on the scope of the present invention. Process 900 in accordance with the present invention is applicable in any applications for identifying the nature of a gateway, a NAT device, or a firewall. Process 900 is implemented with the help of two external hosts, which are referred to as a broker A and a broker B for identification purposes during the explanation of process 900. Each of brokers A and B has a network address and a plurality of ports.

Process 900 of identifying the nature of a gateway starts with a step 902, in which an internal site behind the gateway sends an outgoing data packet to a first port on broker A. The data packet contains information about a port on the internal site. The outgoing data packet opens a port on the gateway. If the gateway is a firewall, it generates a masquerading table that includes the first port on broker A and the network address of broker A as two of its entries. In a step 904, broke A sends a response packet addressed directly to the port on the internal site. In a step 905, process 900 checks whether the internal site receives the response packet from broker A directly addressed to the port on the internal site. If the internal site receives the response packet, process 900, in a step 906, identifies the gateway as not being a firewall. If the internal site does not receive the response packet addressed directly to the port thereon, process 900, in a step 908, identifies the gateway as a firewall.

In a step 912, broker A sends a first data packet from the first port thereon to the port on the gateway. The port on the gateway should recognize the first port of the broker A as the entries in its masquerading table. In a step 915, process 900 checks whether the internal site receives the first data packet from the first port on broker A. If the internal site does not receive the first data packet, process 900 identifies the gateway as blocking all User Datagram Protocol (UDP) data transmissions in a step 908. A site behind such a gateway is not suitable for being a node in a data transmission system, e.g., system 100 or 600 shown in FIG. 1 or 6, in accordance with the present invention.

In response to the internal site receiving the first data packet from the first port on broker A, process 900, in a step 922, sends a second data packet from a second port on broker A to the port on the gateway. In a step 925, process 900 checks whether the internal site receives the second data packet. If the internal site does not receive the second data packet, process 900, in a step 926, identifies the gateway as a strict firewall.

In response to the internal site receiving the second data packet from the second port on broker A, process 900, in a step 932, instructs broker A to send a message to broker B. The message to broker B includes the network address of the gateway and the port address on the gateway. In a step 934, broker B sends a third data packet from a port on broker B to the port on the gateway. In a step 935, process 900 checks whether the internal site receives the third data packet. If the internal site does not receive the second data packet, process 900, in a step 936, identifies the gateway as a semi-promiscuous firewall. In the internal site receives the third data packet, process 900, in a step 938, identifies the gateway as a promiscuous firewall.

It should be understood that process 900 of identifying the nature of a gateway in accordance with the present invention is not limited to that described herein above with reference to FIG. 9. Various modifications can be made to process 900 described above and still achieve the result of identifying the nature of the gateway. For example, step 904 of sending a response packet addressed directly to the port on the internal site, step 912 of sending the first data packet from the first port on broker A, step 922 of sending the second data packet from the second port of broker A, and step 934 of sending the third packet from a port on broker B are not limited to being performed in the order described herein above with reference to FIG. 9. These four data packets can be sent in any order and process 900 will still be able to identify the nature of the gateway in response to the internal site receiving which, if any, of the four data packets. In addition, the response packet addressed directly to the port on the internal site is not limited to being sent from broker A. The response packet addressed directly to the port on the internal site for identifying whether the gateway is a firewall can also be sent from broker B or any other external site. Furthermore, using both broker A and broker B is required only if one seeks to identify whether the gateway is a promiscuous firewall. In an application for identifying whether the gateway is a strict firewall or a non-strict firewall, one broker is sufficient.

By now it should be appreciated that a data transmission system for performing multicasting or cascading broadcasting has been provided. A data transmission system in accordance with the present invention includes a hierarchy tree structure coupled to a data stream source. A root node of the tree structure receives data stream from a data stream source and reflects the data stream to its children, which in turn relay the data stream to their respective children. The data transmission system utilizes the up-link transmission capacities of the nodes in the tree structure to broadcast the data streams, thereby significantly reducing the load on the data stream source and allowing the data stream source to feed data streams to more clients compared with prior art data transmission systems.

It should also be appreciated that a process for constructing and managing such a data transmission system has been provided. A process for connecting clients into a hierarchy structured data transmission system in accordance with the present invention includes directing a client requesting for connection into the data transmission system to a location in the system based on such criteria as data transmission capacity, firewall compatibility, geographic location, network compatibility, etc. The process forms a data transmission or broadcasting system that is both stable and efficient. The process also monitors the quality of data streams received by a client in the system and dynamically adjusts the system structure to maintain a high quality of data transmission.

It should be further appreciated that a process for transmitting data to a network site behind a firewall and between two network sites behind different firewalls has been provided. A process in accordance with the present invention uses an external site to relay the initial connection requests in establishing the data transmission links for users behind firewalls. The process also uses the external site to send data packets to an internal site to identify the nature of the firewalls.

While various embodiments of the present invention have been described with reference to the drawings, these are not intended to limit the scope of the present invention, which is set forth in the appending claims. Various modifications of the above described embodiments can be made by those skilled in the art after browsing the specification of the subject application. These modifications are within the scope and true spirit of the present invention.

1. A process for transmitting data over a network, comprising the steps of:
receiving a connection request from a requesting client;
evaluating a node distribution of a hierarchy structure having a content provider as a root thereof;
connecting the requesting client to the content provider in response to the node distribution exceeding a range;
directing the requesting client to a first tree having a first child of the content provider as a root node thereof in response to the node distribution within the range;
transmitting data from the content provider to the requesting client in response to connecting the requesting client to the content provider; and
relaying the data through the root node of the first tree to the requesting client in response to directing the requesting client to the first tree.

2. The process of claim 1, wherein:
the step of connecting the requesting client includes connecting the requesting client to the content provider further in response to the content provider having a capacity therefor the requesting client; and
the step of directing the requesting client includes directing the requesting client to the first tree further in response to the first tree having a capacity for the requesting client.

3. The process of claim 1, wherein the step of directing the requesting client to a first tree includes the steps of:
evaluating a node distribution of the first tree;
connecting the requesting client to the root node of the first tree in response to the node distribution exceeding a standard value; and
recursively directing the requesting client to a descendent of the root node of the first tree in response to the node distribution not exceeding the standard value.

4. The process of claim 3, further comprising the step of directing the requesting client to a descendent of the root node of the first tree in response to the requesting client having an up-link quality not meeting a predetermined standard.

5. The process of claim 3, wherein the step of recursively directing the requesting client to a descendent of the root node of the first tree includes the steps of:
selecting a descendent of the node root of the first tree as a current node;
evaluating a node distribution of a subtree having the current node as a root node thereof;
connecting the requesting client to the current node in response to the node distribution exceeding the standard value; and
recursively directing the requesting client to a descendent of the current node in response to the node distribution not exceeding the standard value.

6. The process of claim 5, further comprising the step of redirecting the requesting client to the content provider in response to neither the current node nor a descendent thereof having a capacity for the requesting client.

7. The process of claim 6, wherein the step of redirecting the requesting client further includes the steps of:
increasing a redirect count associated with the requesting client;
connecting the requesting client to the content provider in response to the redirect count exceeding a first limit; and
searching a spot for the requesting client in the hierarchy structure in response to the redirect count below the first limit.

8. The process of claim 7, wherein the step of searching a spot for the requesting client in the hierarchy structure further includes the steps of:
recursively visiting a node in the hierarchy structure searching the spot for the requesting client; and
connecting the requesting client to the node in response to the redirect count exceeding a second limit and to the node having a capacity.

9. The process of claim 3, further comprising the step of directing the requesting client toward a node selected from a plurality of nodes in the hierarchy structure in accordance with a plurality of scores reflecting a plurality of qualities of the plurality of nodes.

10. The process of claim 9, further comprising, in response to the requesting client being external, the steps of:
assigning a first score to the node in response to the node behind a firewall; and
assigning a second score higher than the first score to the node in response to the node being external.

11. The process of claim 9, further comprising, in response to the requesting client behind a firewall, the steps of:
assigning a first score to a node in the hierarchy structure in response to the node behind the firewall;
assigning a second score lower than the first score to the node in response to the node being external;
assigning a third score lower than the second score to the node in response to the node behind a second firewall different from the firewall and to the node being able to communicate with the requesting client through the firewall and the second firewall; and
assigning a fourth score lower than the third score to the node in response to the node behind the second firewall and to the node being unable to communicate with the requesting client through the firewall and the second firewall.

12. The process of claim 9, further comprising the step of assigning a score to a node in the hierarchy structure in accordance with a time zone offset between the node and the requesting client.

13. The process of claim 9, further comprising the step of assigning a score to a node in the hierarchy structure in accordance with a match between an address of the node and an address of the requesting client.

14. The process of claim 9, further comprising the steps of:
assigning a first score to a node in the hierarchy structure based on a capacity of the node in response to the requesting client being external;
assigning the first score to the node in response to the requesting client behind a firewall and the node behind the firewall; and
assigning a second score equal to the first score multiplied by a factor less than one to the node in response to the requesting client behind a firewall and the node not behind the firewall

15. The process of claim 9, further comprising the steps of:
assigning a first score to a node in the hierarchy structure in response to the node having an Autonomous System Number equal to that of the requesting client; and
assigning a second score lower than the first score to the node in response to the node having am Autonomous System Number different from that of the requesting client.

16. The process of claim 9, further comprising the step of assigning a score to a node in the hierarchy structure in accordance with a history of the node being visited.

17. The process of claim 1, further comprising the steps of:
monitoring a quality of data transmitted to a client; and
relocating the client in response to the quality of data transmitted to the client below a standard.

18. The process of claim 17, wherein the step of relocating the client further includes the steps of:
identifying a parent of the client as a marked node;
disconnecting the client from the parent; and
searching a new spot for the client, the new spot not being a child of the marked node.

19. The process of claim 18, wherein the step of relocating the client further includes the steps of:
evaluating a capacity of a sibling of the client;
connecting the client as a child of the sibling in response the sibling having the capacity for the client; and
generating a reconnection request in response to the sibling not having the capacity for the client.

20. The process of claim 19, wherein the step of relocating the client further includes the steps of:
receiving the reconnection request from the client at a client connection manager; and
recursively searching the new spot for the client.

21. A storage medium having a data streaming network management program stored thereon, said data streaming network management program, when executed by a digital signal processing unit, performing a network management process comprising the steps of:
receiving a connection request from a client;
verifying whether there is a hierarchy structure with at least one tree having a root node thereof connected to a data stream source;
in response to there be not a hierarchy structure, forming a tree with the client as a root node thereof and connecting the client to the data stream source;
in response to there be a hierarchy structure, evaluating a node distribution of the hierarchy structure; and
in response to the node distribution within a range, directing the client to a tree in the at least one tree in the hierarchy structure.

22. The storage medium of claim 21, said network management process further comprising the step of, in response the node distribution exceeding the range, connecting the client to the data stream source.

23. The storage medium of claim 21, said network management process further comprising the step of, in response the client having an up-link capability exceeding a standard, connecting the client to the data stream source.

24. The storage medium of claim 21, wherein the step of directing the client to a tree in the at least one tree in the hierarchy structure in said network management process further includes the step of recursively searching a spot for the client in the hierarchy structure.

25. The storage medium of claim 24, wherein the step of directing the client to a tree in the at least one tree in the hierarchy structure in said network management process further includes the step of, in response to the tree not having a capacity for the client, directing the client to the data stream source.

26. The storage medium of claim 24, wherein the step of recursively searching a spot for the client in the hierarchy structure in said network management process further includes the steps of:
selecting a node in the hierarchy structure as a current node;
evaluating a structure parameter of the current node;
in response to the structure parameter exceeding a value, connecting the client to the current node; and
in response to the structure parameter below the value, selecting a child of the current node as a new current node.

27. The storage medium of claim 26, wherein the step of selecting a child of the current node as a new current node in said network management process further includes the steps of:
evaluating a structure parameter of the new current node;
in response to the structure parameter exceeding the value, connecting the client to the new current node; and
in response to the structure parameter below the value, directing the client to a subtree having a child of the new current node as a root node thereof.

28. The storage medium of claim 26, wherein the step of selecting a node in the hierarchy structure as a current node in said network management process further includes the step of selecting the node in accordance with a preference factor assigned to the node.

29. The storage medium of claim 28, said network management process further comprising the step of assigning the preference factor to the node calculated from a history of the node being visited by a requesting client seeking for connection to the node.

30. The storage medium of claim 28, said network management process further comprising the step of assigning the preference factor to the node calculated from a time zone offset between the node and the client.

31. The storage medium of claim 28, said network management process further comprising, in response to the client being external, the steps of:
in response to the node being external, assigning a first preference factor to the node; and
in response to the node behind a firewall, assigning a second preference factor smaller than the first preference factor to the node.

32. The storage medium of claim 28, said network management process further comprising, in response to the client behind a firewall, the steps of:
in response to the node behind the firewall, assigning a first preference factor to the node;
in response to the node being external, assigning a second preference factor smaller than the first preference factor to the node;
in response to the node behind a second firewall different from the firewall and to the node being able to communicate with the requesting client through the firewall and the second firewall, assigning a third preference factor smaller than the second preference factor to the node; and
in response to the node behind the second firewall and to the node being unable to communicate with the requesting client through the firewall and the second firewall, assigning a fourth preference factor smaller than the third preference factor to the node.

33. The storage medium of claim 28, said network management process further comprising the step of assigning the preference factor to the node calculated from a mismatch between an address of the node and an address of the requesting client.

34. The storage medium of claim 28, said network management process further comprising the steps of:
in response to the client being external, assigning a first preference factor to the node calculated from a capacity of the node;
in response to the client behind a firewall and the node behind the firewall, assigning the first preference factor to the node; and
in response to the client behind a firewall and the node not behind the firewall, assigning a second preference factor equal to the first preference factor multiplied by a factor less than one to the node.

35. The storage medium of claim 28, said network management process further comprising the step of assigning the preference factor to the node in response to the node calculated from a mismatch between an Autonomous System Number of the node and that of the client.

36. The storage medium of claim 21, said network management process further comprising, in response to a quality of data transmitted to the client below a standard, the step of relocating the client.

37. The storage medium of claim 36, wherein the step of relocating the client in said network management process further includes the steps of:
identifying a parent of the client as a marked node; and
searching a new spot for the client, the new spot not being a child of the marked node.

38. The storage medium of claim 37, wherein the step of relocating the client in said network management process further includes the steps of:
in response a sibling of the client having a capacity for the client, connecting the client as a child of the sibling; and
in response to the sibling not having the capacity for the client, directing the client to the data stream source.

39. The storage medium of claim 38, wherein the step of relocating the client in said network management process further includes the step of recursively searching the new spot for the client in the hierarchy structure.

40. The process of claim 36, said network management process further comprising the step monitoring a jitter of a data stream transmitted to the client.

41. A network data transmission system, comprising:
a content provider;
a plurality of clients seeking data from said content provider; and
a client connection manager, said client connection manager arranging said plurality of clients in a hierarchy tree structure having a first client of said plurality of clients coupled to said content provider as a node in a first tier of the hierarchy tree structure and at least a portion of remaining clients of said plurality of clients as a descendent of the first client.

42. The network data transmission system of claim 41, the first client receiving data from said content provider and relaying the data to the descendent thereof.

43. The network data transmission system of claim 42, said plurality of clients further including a second client, the second client being a child of the first client in the hierarchy tree structure and receiving the data from the first client.

44. The network data transmission system of claim 43, said plurality of clients further including a third client, the third client being a child of the second client in the hierarchy tree structure and receiving the data from the second client.

45. The network data transmission system of claim 43, said plurality of clients further including a third client, the third client being a child of the first client and a sibling of the second client in the hierarchy tree structure and receiving the data from the first client.

46. The network data transmission system of claim 41, said plurality of clients further including a second client coupled to said content provider as a node in a first tier of a second hierarchy tree structure, the second client receiving data from said content provider.

47. The network data transmission system of claim 46, said plurality of clients further including a third client, the third client being a child of the second client in the second hierarchy tree structure and receiving the data from the second client.

48. The network data transmission system of claim 47, said plurality of clients further including a fourth client, the fourth client being a child of the third client in the second hierarchy tree structure and receiving the data from the third client.

49. The network data transmission system of claim 47, said plurality of clients further including a fourth client, the fourth client being a child of the second client and a sibling of the third client in the second hierarchy tree structure and receiving the data from the second client.

50. The network data transmission system of claim 41:
said client connection manager arranging said plurality of clients into the hierarchy tree structure in response to data transmission capacities of said content provider and said plurality of clients; and
said client connection manager dynamically adjusting the hierarchy tree structure in response to a data transmission quality in the hierarchy tree structure.

51. A method for communicating between a first site behind a first firewall and a second site behind a second firewall, comprising:
informing the second site about a port on the first firewall;
transmitting a first data packet addressed to the port on the first firewall from the second site through a port on the second firewall;
relaying the first data packet to the first site in response to the first firewall being promiscuous;
transmitting a second data packet addressed to the port on the second firewall from the first site through the port on the first firewall; and
relaying the second data packet to the second site.

52. The method of claim 51, wherein informing the second site about a port on the first firewall further includes:
establishing a first link between the first site and an external site through the port on the first firewall;
establishing a second link between the second site and the external site through the second firewall; and
transmitting a message from the external source to the second site identifying the port on the first firewall.

53. The method of claim 52, wherein establishing a first link between the first site and an external site through the port on the first firewall and establishing a second link between the second site and the external site through the second firewall further include:
transmitting a first initializing data packet from the first site to the external site through the port on the first firewall; and
transmitting a second initializing data packet from the second site to the external site through the second firewall.

54. The method of claim 51, further comprising identifying the first firewall as promiscuous.

55. The method of claim 54, wherein identifying the first firewall includes:
transmitting an outgoing data packet from the first site to the external site through the port on the first firewall;
informing a second external site about the port on the first firewall, the second external site having a different network address from the first external site;
transmitting an incoming data packet addressed to the port on the first firewall from the second external site; and
identifying the first firewall as being promiscuous in response to the first site receiving the incoming data packet.

56. A method for communicating between a first site behind a first firewall and a second site behind a second firewall, comprising:
informing the first site about the second firewall;
informing the second site about a port on the first firewall;
transmitting a first data packet addressed to the second firewall through the port on the first firewall;
transmitting a second data packet addressed to the port on the first firewall from the second site through a port on the second firewall;
relaying the second data packet to the first site in response to the first firewall being non-strict;
transmitting a third data packet addressed to the port on the second firewall from the first site through the port on the first firewall; and
relaying the third data packet to the second site.

57. The method of claim 56, wherein informing the first site about the second firewall and informing the second site about a port on the first firewall further include:
establishing a first link between the first site and an external site through the port on the first firewall and a second link between the second site and the external site through the second firewall;
transmitting a first message from the external source to the first site identifying the second firewall; and
transmitting a second message from the external source to the second site identifying the port on the first firewall.

58. The method of claim 57, wherein establishing a first link between the first site and an external site through the port on the first firewall and a second link between the second site and the external site through the second firewall further includes:
transmitting a first initializing data packet from the first site to the external site through the port on the first firewall; and
transmitting a second initializing data packet from the second site to the external site through the second firewall.

59. The method of claim 56, further comprising identifying the first firewall as non-strict.

60. The method of claim 59, wherein identifying the first firewall includes:
transmitting an outgoing data packet from the first site to a first port of the external site through the port on the first firewall;
transmitting an incoming data packet addressed to the port on the first firewall from a second port on the external source, the second port being different from the first port; and
identifying the first firewall as being non-strict in response to the first site receiving the incoming data packet.
